(19) United States
(12) Patent Application Publication
(10) Pub. No.: US 2025/0296071 A1
(43) Pub. Date: Sep. 25, 2025

(54) MIXED-METAL MIXED-ORGANIC FRAMEWORK SYSTEMS FOR SELECTIVE CO2 CAPTURE

(71) Applicant: EXXONMOBIL TECHNOLOGY AND ENGINEERING COMPANY, Spring, TX (US)

(72) Inventors: Simon C. WESTON, Annandale, NJ (US); Carter W. ABNEY, Califton, NJ (US); Joseph M. FALKOWSKI, Hampton, NJ (US); Anna C. IVASHKO, Denville, NJ (US)

(21) Appl. No.: 19/228,269

(22) Filed: Jun. 4, 2025

Related U.S. Application Data
(63) Continuation of application No. 17/601,610, filed on Oct. 5, 2021.
(60) Provisional application No. 62/839,261, filed on Apr. 26, 2019.

(51) Int. Cl. B01J 20/22; B01D 53/02; C07F 13/00

(52) U.S. Cl. CPC B01J 20/226; B01D 53/02; C07F 13/00; B01D 2253/204; B01D 2257/504; B01J 2220/46

(57) ABSTRACT

Provided herein are adsorption materials comprising a mixed-metal mixed-organic framework comprising metal ions of two or more distinct metals and a plurality of organic linkers. Each organic linker in the plurality of organic linkers is connected to a metal ion. The adsorption material further comprises a plurality of ligands. In an aspect, each respective ligand in the plurality of ligands is an amine or other Lewis base (electron donor) appended to a metal ion in the two of more distinct elements of the mixed-metal organic framework to provide a mixed-metal mixed-organic framework system.

### CROSS-REFERENCE TO RELATED APPLICATIONS AND PRIORITY CLAIM

This Non-Provisional Patent application is a Continuation of U.S. patent application Ser. No. 17/601,610, filed Oct. 5, 2021, titled “Mixed-Metal, Mixed-Organic Framework Systems For Selective CO2 Capture”, which a National Stage of PCT/US2020/029854, filed Apr. 24, 2020, titled “Mixed-Metal, Mixed-Organic Framework Systems For Selective CO2 Capture”, which claims the benefit of priority to U.S. Provisional Patent Application No. 63/839,261 filed Apr. 26, 2019, titled “Mixed-Metal, Mixed-Organic Framework Systems For Selective CO2 Capture”, all of which are incorporated herein by reference in their entirety.

### FIELD OF THE INVENTION

The present invention relates to systems of modified mixed-metal, mixed-organic frameworks for selective CO₂ capture and methods of using the same.

### BACKGROUND OF THE INVENTION

The combustion of fossil fuels results in emission of CO₂, a large component of anthropogenic contributions to global climate change. In addition to environmental effects, tax penalties and/or incentives related to CO₂ emissions pose a significant financial consideration for infrastructure development, energy production, and manufacturing. The crux of the problem is that the concentration of CO₂ emitted can vary dramatically between applications, and is most commonly diluted with the benign atmospheric gas N₂. Nevertheless, the quantity of CO₂ emitted is massive. Thus, what is required is a technology capable of selectively removing diluted CO₂ from gas streams, with performance which can be tuned for implementation in diverse applications, and where the CO₂ can be easily and economically recovered for use or storage in turn regenerating the adsorbent technology for reuse.

Prior solutions for CO₂ capture primarily focus on liquid amine solutions, which are expensive to regenerate, cause engineering challenges due to changes in physical properties as CO₂ is adsorbed, and are mildly corrosive. More recently developed technologies include water-lean solutions, which display modest improvements in CO₂ capture performance, but are markedly more expensive than aqueous amines and still suffer from engineering challenges due to changes in physical properties. Solid-phase adsorbents, such as polymers and zeolites, have also been explored for CO₂ capture. The former typically suffer from low selectivity and poor capacity, while the latter are readily de-activated by water, requiring impractical pre-treatment of emissions prior to CO₂ removal.

In addition, prior art metal-organic frameworks have been reported for selective CO₂ capture, prepared from single metal framework materials and functionalized post-synthesis with various diamines. In these systems, while selection of diamine provides some degree to which CO₂ capture performance can be tuned, the limitations in diamine diversity and availability reduces the extent to which the material may be optimized for specific emission streams.

A need exists, therefore, for framework systems that can be adjusted and/or modified so to regulate CO₂ adsorption to a required level and capture CO₂ from different emission streams.

### SUMMARY OF THE INVENTION

Provided herein are mixed-metal organic frameworks having an empirical or chemical formula of two or more distinct metallic elements and bridged by a linker. The subject mixed-metal organic frameworks comprise a plurality of disalicylate linkers, where each linker comprises one or more aromatic rings, each aromatic ring comprising a carboxylate functional group and an alcohol functional group, the carboxylate functional group, and the alcohol functional groups are adjacent to one another on each aromatic ring. In addition, each aromatic ring is positioned at a greatest distance from the other.

Further provided are mixed-metal organic frameworks having the formula: M¹xM²₍₂₋ₓ₎(A) where M¹ and M² are each independently different metal cations, and A is a disalicylate organic linker. In an aspect, M¹ and M² are both independently a divalent metal cation. In an aspect, M¹ and M² are selected independently from Ca²⁺, Mg²⁺, Fe²⁺, Cr²⁺, V²⁺ Mn²⁺, Co²⁺, Ni²⁺, Zn²⁺, Cu²⁺ . . . . In an aspect, A is a plurality of disalicylate organic linkers selected independently from a group consisting of:

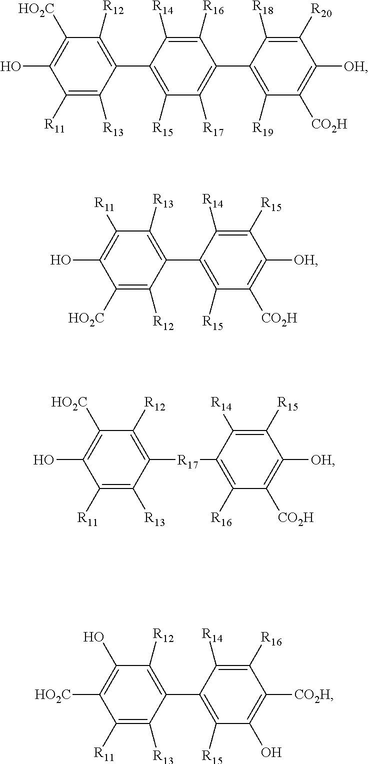

wherein R₁₁, R₁₂, R₁₃, R₁₄, R₁₅, R₁₆, R₁₇, R₁₈, R₁₉, and R₂₀ are each independently selected from H, halogen, hydroxyl, methyl, and halogen substituted methyl; and R₁₇ is selected from the group consisting of substituted or unsubstituted aryl, vinyl, alkynyl, substituted or unsubstituted heteroaryl, divinyl benzene, and diacetyl benzene.

In an aspect, the mixed metal organic frameworks provide an X-ray diffraction pattern having a unit cell that can be indexed to a hexagonal unit cell. In an aspect, the unit cell is selected from spacegroups 168 to 194 as defined in the International Tables for Crystallography. In an aspect, the present mixed-metal organic frameworks further comprise a metal rod structure described by the Lidin-Andersson helix, as described by Schoedel, Li, Li, O'Keeffe, and Yaghi, Chem Rev. 2016 116, 12466-12535. In an aspect, the mixed-metal organic framework has a hexagonal pore oriented parallel to the metal rod structure. In an aspect, the present mixed-metal organic frameworks display a (3,5,7)-c msi net, according to the approach described by Schoedel, Li, Li, O'Keeffe, and Yaghi, Chem Rev. 2016 116, 12466-12535. In an aspect, The mixed-metal organic framework displays a (3,5,7)-c msg net, according to the approach described by Schoedel, Li, Li, O'Keeffe, and Yaghi, Chem Rev. 2016 116, 12466-12535.

In an aspect, the subject mixed-metal organic frameworks express peak maxima in the X-ray diffraction pattern at 30° C. after drying at 250° C. under N₂ for 30 minutes at:

```
d(Å)
18.65 ± 0.5
10.79 ± 0.5
  9.35 ± 0.5
  7.07 ± 0.5
  6.51 ± 0.5
  6.24 ± 0.5
  5.84 ± 0.5
  5.41 ± 0.5
  5.19 ± 0.5
```

In an aspect, the express peak maxima in the X-ray diffraction pattern at 30° C. after drying at 250° C. under N₂ for 30 minutes at:

```
d(Å)
18.65 ± 0.5
10.79 ± 0.5
  7.07 ± 0.5
  5.41 ± 0.5
  5.19 ± 0.5
```

In an aspect, an A axis of the unit cell and a B axis of the unit cell are each greater than 18 Å, and a c axis is greater than 6 Å.

Further provided herein are mixed-metal mixed-organic framework systems comprising the subject mixed-metal organic framework and a ligand comprising an amine. In an aspect, the ligand is a diamine. In an aspect, the diamine is a cyclic diamine. In an aspect, the diamine is independently selected from:

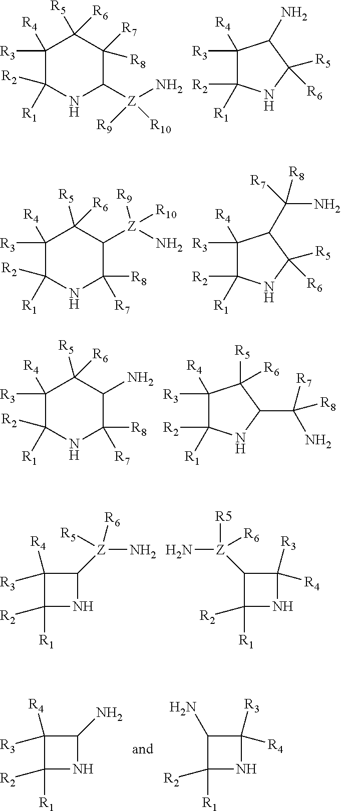

wherein Z is independently selected from carbon, silicon, germanium, sulfur and selenium; and R₁, R₂, R₃, R₄, R₅, R₆, R₇, R₈, R₉, and R₁₀, are each independently selected from H, halogen, methyl, halogen substituted methyl and hydroxyl.

In an aspect, the diamine ligand is selected from one of: dimethylethylenediamine (mmen) or 2-(aminomethyl) piperidine (2-ampd). In an aspect, the ligand is a tetramine. In an aspect, the tetramine is selected from one of 3-4-3 tetramine (spermine) or 2-2-2 tetramine.

In an aspect, the mixed-metal organic framework system comprises a secondary ligand, where the secondary ligand is a triamine. In an aspect, the secondary ligand is selected from:

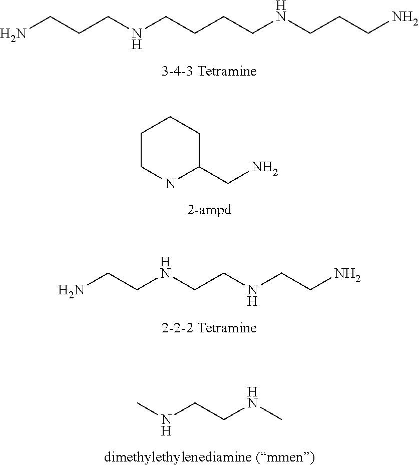

Also provided are methods of synthesizing a mixed-metal organic framework comprising the steps of: contacting a solution comprising two or more sources of two or more distinct metallic elements and an organic linker capable of bridging metal cations and heating the mixture to produce one or more of the present mixed-metal organic frameworks. In an aspect, the two or more distinct metallic elements are independently selected from Ca, Mg, Fe, Cr, V, Mn, Co, Ni, Zn, Cu. In an aspect, the solution comprises an elemental metal or a salt of the metal in which the counter anion comprises a nitrate, acetate, carbonate, oxide, hydroxide, fluoride, chloride, bromide, iodide, phosphate, or acetylacetonate.

Further provided are methods of synthesizing the mixed-metal organic frameworks comprising the steps of contacting the mixed-metal organic framework with a secondary ligand in a gas or liquid medium. In an aspect, the ligand is an amine-containing molecule. In an aspect, the ligand is a diamine. In an aspect, the ligand is a triamine. In an aspect, the ligand is a tetramine.

Provided herein are particles comprising one or more of the subject mixed-metal mixed-organic framework system. Also, provided herein is an adsorbent material comprising the subject mixed-metal mixed-organic framework system. In an aspect, the mixed-metal mixed-organic framework displays a Type-V isotherm profile for CO₂. Also, provided are methods of adsorbing carbon dioxide is from a carbon-dioxide containing stream by contacting said stream with one or more of the present adsorbents. Further provided are methods of tuning the position of a step of a Type-V CO₂ isotherm comprising the step of varying an amount, or a type, of the metal ions of two or more distinct metals of the mixed-metal organic frameworks or mixed-metal mixed-organic framework systems.

### BRIEF DESCRIPTION OF THE DRAWINGS

FIG. 1 is a powder x-ray diffraction pattern of a representative mixed-metal MOF-274 framework system.

FIGS. 2A, 2B, 2C, 2D and 2E depict representative data collected by energy-dissipative x-ray spectroscopy (“EDS”).

FIG. 3 is normalized x-ray absorption spectroscopy data for Ni₁Mg₁-MOF-274 (50% Ni), collected at the Ni K-edge. It is critical to note that the feature around 2.5 Å decreases as the Mg: Ni ratio increases.

FIG. 4 is a comparison of the scattering paths that reveal Mg is a weaker backscatterer than Ni.

FIG. 5 is a representative fitted extended x-ray absorption fine structure (EXAFS) spectrum for a Ni₁Mg₁-MOF-274 (50% Ni) framework system.

FIG. 6 is a representative powder x-ray diffraction pattern of mixed-metal framework system EMM-44 (the 2-ampd-appended mixed-metal MOF-274 framework system).

FIG. 7 is a representative 1H NMR of mixed-metal mixed-organic framework system EMM-44, following digestion with DCI in DMSO-d₆.

FIG. 8 are CO₂ isotherms for Mn_{0.1}Mg_{1.9}-EMM-44 (5% Mn), Mn_{0.2}Mg_{1.8}-EMM-44 (10% Mn), Mn_{0.5}Mg_{1.5}-EMM-44 (25% Mn) and Mn₁Mg₁-EMM44 (50% Mn) MOF-274, displaying an unusual and highly desired type-V isotherm.

FIG. 9 is CO₂ isotherm for Mn_{0.1}Mg_{1.9}-EMM-44 (5% Mn), Mn_{0.2}Mg_{1.8}-EMM-44 (10% Mn), Mn_{0.5}Mg_{1.5}-EMM-44 (25% Mn) and Mn₁Mg₁-EMM44 (50% Mn) MOF-274 plotted on a log scale to more fully display the characteristic low-pressure step in the Type-V isotherm.

FIG. 10. shows a position of the CO₂-isotherm midpoint versus Mn loading for MnₓMg₂₋ₓ-EMM-44.

FIG. 11 illustrates the structure of a diamine-appended metal organic framework EMM-44.

### DESCRIPTION OF THE PREFERRED EMBODIMENTS

Provided herein are mixed-metal organic frameworks comprising metal ions of two or more distinct elements and a plurality of organic linkers, where each organic linker is connected to one of the metal ions of two or more distinct elements. Further provided are mixed-metal mixed-organic framework systems comprising a mixed-metal mixed-organic framework and a ligand. The mixed-metal mixed-organic framework comprises metal ions of two or more distinct elements and a plurality of organic linkers, where the organic linker is connected to one of the metal ions of two or more distinct elements.

In an aspect, the mixed-metal organic framework comprises two or more distinct elements independently selected from the group of Mg, Ca, V, Mn, Cr, Fe, Co, Ni, Cu and Zn. In an aspect, each of the two or more distinct elements is Mg, Mn, Ni, or Zn. In an aspect, the mixed-metal organic framework comprises a ligand selected from the group of diamine, cyclic diamine, triamine, and/or tetramine. In an aspect, the ligand is an organic diamine. In an aspect, the ligand is amine 2-(aminomethyl) piperidine (“2-ampd”). In an aspect, the mixed-metal mixed-organic framework system displays a Type-V step CO₂ isotherm profile upon exposure to carbon dioxide. In an aspect, the Type-V step is adjusted through metal selection and/or ratio of metals incorporated into the mixed-metal framework.

Also, provided is an adsorbent material comprising the mixed-metal mixed-organic framework system described herein. Further provided are methods of removing carbon dioxide from a feed comprising the step of passing the feed over the mixed-metal mixed-organic framework system. In addition, methods of adjusting a position of a step of a Type-V isotherm comprising the step of varying one or more of the metal ions of two or more distinct elements of the mixed-metal mixed-organic framework system.

In an aspect, provided herein is a mixed-metal organic framework of general structural Formula I

M¹xM²₍₂₋ₓ₎(A) I

wherein M¹ is a metal or salt thereof, and M² is a metal or salt thereof, but M¹ is not M²; X is a value from 0.01 to 1.99; and A is a plurality of organic linkers.

Further, in an aspect, provided is a mixed-metal mixed-organic framework system of general structural Formula II

M¹ₓM²₍₂₋ₓ₎(A)(B) II

wherein M¹ is independently selected from Mg, Ca, V, Mn, Cr, Fe, Co, Ni, Cu and Zn; M² is independently selected from Mg, Ca, V, Mn, Cr, Fe, Co, Ni, Cu and Zn, and M¹ is not M²; X is a value from 0.01 to 1.99; A is an organic linker; and B is a ligand.

Before the present methods and devices are disclosed and described, it is to be understood that unless otherwise indicated this invention is not limited to specific compounds, components, compositions, reactants, reaction conditions, ligands, catalyst structures, metallocene structures, or the like, as such may vary, unless otherwise specified. It is also to be understood that the terminology used herein is for the purpose of describing particular embodiments only and is not intended to be limiting.

For the purposes of this disclosure, the following definitions will apply:

As used herein, the terms “a” and “the” as used herein are understood to encompass the plural as well as the singular.

As used herein, the term “heteroatom” includes oxygen (O), nitrogen (N), sulfur(S) and silicon (Si), boron (B) and phosphorous (P).

The term “aryl” means, unless otherwise stated, a polyunsaturated, aromatic substituent that can be a single ring or multiple rings fused together or linked covalently. In an aspect, the substituent has from 1 to 11 rings, or more specifically, 1 to 3 rings. The term “heteroaryl” refers to aryl substituent groups (or rings) that contain from one to four heteroatoms selected from N, O and S, wherein the nitrogen and sulfur atoms are optionally oxidized, and the nitrogen atom(s) are optionally quaternized. An exemplary heteroaryl group is a six-membered azine, e.g., pyridinyl, diazinyl and triazinyl. A heteroaryl group can be attached to the remainder of the molecule through a heteroatom. Non-limiting examples of aryl and heteroaryl groups include phenyl, 1-naphthyl, 2-naphthyl, 4-biphenyl, 1-pyrrolyl, 2-pyrrolyl, 3-pyrrolyl, 3-pyrazolyl, 2-imidazolyl, 4-imidazolyl, pyrazinyl, 2-oxazolyl, 4-oxazolyl, 2-phenyl-4-oxazolyl, 5-oxazolyl, 3-isoxazolyl, 4-isoxazolyl, 5-isoxazolyl, 2-thiazolyl, 4-thiazolyl, 5-thiazolyl, 2-furyl, 3-furyl, 2-thienyl, 3-thienyl, 2-pyridyl, 3-pyridyl, 4-pyridyl, 2-pyrimidyl, 4-pyrimidyl, 5-benzothiazolyl, purinyl, 2-benzimidazolyl, 5-indolyl, 1-isoquinolyl, 5-isoquinolyl, 2-quinoxalinyl, 5-quinoxalinyl, 3-quinolyl, and 6-quinolyl. Substituents for each of the above noted aryl and heteroaryl ring systems are selected from the group of acceptable substituents described below.

As used herein, the terms “alkyl,” “aryl,” and “heteroaryl” can optionally include both substituted and unsubstituted forms of the indicated species. Substituents for the aryl and heteroaryl groups are generically referred to as “aryl group substituents.” The substituents are selected from, for example: groups attached to the heteroaryl or heteroarene nucleus through carbon or a heteroatom (e.g., P, N, O, S, Si, or B) including, without limitation, substituted or unsubstituted alkyl, substituted or unsubstituted aryl, substituted or unsubstituted heteroaryl, substituted or unsubstituted heterocycloalkyl, —OR′, ═O, ═NR′, ═N—OR′, —NR′R″, —SR′, -halogen, —SiR′R″R″, —OC(O)R′, —C(O)R′, --CO.sub.2R′, —CONR′R″, —OC(O)NR′R″, —NR″C(O)R′, —NR′—C(O) NR″R″, —NR″C(O).sub.2R′, —NR—C(NR′R″R″).dbd.NR″, —NR—C(NR′R″)═NR″, —S(O)R′, —S(O)R′, —S(O)NR′R″, —NRSOR′, —CN and, —R′, --, —CH(Ph), fluoro(C₁-C₄) alkoxy, and fluoro (C₁-C₄) alkyl, in a number ranging from zero to the total number of open valences on the aromatic ring system. Each of the above-named groups is attached to the aryl or heteroaryl nucleus directly or through a heteroatom (e.g., P, N, O, S, Si, or B); and where R′, R″, R′″ and R″ are preferably independently selected from hydrogen, substituted or unsubstituted alkyl, substituted or unsubstituted heteroalkyl, substituted or unsubstituted aryl and substituted or unsubstituted heteroaryl. When a compound of the invention includes more than one R group, for example, each of the R groups is independently selected as are each R′, R″, R′″ and R″ groups when more than one of these groups is present.

The term “alkyl,” by itself or as part of another substituent, means, unless otherwise stated, a straight or branched chain, or cyclic hydrocarbon radical, or combination thereof, which may be fully saturated, mono- or polyunsaturated and can include di-, tri- and multivalent radicals, having the number of carbon atoms designated (i.e. C₁-C₁₀ means one to ten carbons). Examples of saturated hydrocarbon radicals include, but are not limited to, groups such as methyl, ethyl, n-propyl, isopropyl, n-butyl, t-butyl, isobutyl, sec-butyl, cyclohexyl, (cyclohexyl)methyl, cyclopropylmethyl, homologs and isomers of, for example, n-pentyl, n-hexyl, n-heptyl, n-octyl, and the like. An unsaturated alkyl group is one having one or more double bonds or triple bonds. Examples of unsaturated alkyl groups include, but are not limited to, vinyl, 2-propenyl, crotyl, 2-isopentenyl, 2-(butadienyl), 2,4-pentadienyl, 3-(1,4-pentadienyl), ethynyl, 1- and 3-propynyl, 3-butynyl, and the higher homologs and isomers. The term “alkyl,” unless otherwise noted, is also meant to optionally include those derivatives of alkyl defined in more detail below, such as “heteroalkyl.”

The term “heteroalkyl,” by itself or in combination with another term, means, unless otherwise stated, a stable straight or branched chain, or cyclic hydrocarbon radical, or combinations thereof, consisting of the stated number of carbon atoms and at least one heteroatom selected from the group consisting of O, N, Si and S, and wherein the nitrogen and sulfur atoms may optionally be oxidized and the nitrogen heteroatom may optionally be quaternized. The heteroatom(s) O, N and S and Si may be placed at any interior position of the heteroalkyl group or at the position at which the alkyl group is attached to the remainder of the molecule. Examples include, but are not limited to, —CH₂—CH₂—O—CH₃, —CH₂—CH.₂—NH—CH₃, —CH₂—CH₂—N(CH₃)—CH₃, —CH₂—S—CH₂—CH₃, —CH₂—CH₂, —S(O)—CH₃, —CH₂—CH₂—S(O)₂—CH₃, —CH═CH—O—CH₃, —Si(CH₃)₃, —CH₂—CH═N—OCH₃, and —CH═CH—N(CH₃)—CH₃. Up to two heteroatoms may be consecutive, such as, for example, —CH₂—NH—OCH₃ and —CH₂—O—Si(CH₃)₃. Similarly, the term “heteroalkylene” by itself or as part of another substituent means a divalent radical derived from heteroalkyl, as exemplified, but not limited by, —CH₂—CH₂—S—CH₂—CH₂—and —CH₂—S—CH₂—CH₂—NH—CH₂—. For heteroalkylene groups, heteroatoms can also occupy either or both chain termini (e.g., alkyleneoxy, alkylenedioxy, alkyleneamino, alkylenediamino, and the like). Still further, for alkylene and heteroalkylene linking groups, no orientation of the linking group is implied by the direction in which the formula of the linking group is written. For example, the formula —CO₂R′—represents both —C(O)OR′ and —OC(O)R′.

As used herein, the term “ligand” means a molecule containing one or more substituent groups capable of functioning as a Lewis base (electron donor). In an aspect, the ligand can be oxygen, phosphorus or sulfur. In an aspect, the ligand can be an amine or amines containing 1 to 10 amine groups.

The terms “halo” or “halogen,” by themselves or as part of another substituent, mean, unless otherwise stated, a fluorine, chlorine, bromine, or iodine atom.

The symbol “R” is a general abbreviation that represents a substituent group that is selected from H, substituted or unsubstituted alkyl, substituted or unsubstituted heteroalkyl, substituted or unsubstituted aryl, substituted or unsubstituted heteroaryl, and substituted or unsubstituted heterocycloalkyl groups.

As used herein, the term “Periodic Table” means the Periodic Table of the Elements of the International Union of Pure and Applied Chemistry (IUPAC), dated December 2015.

As used herein, an “isotherm” refers to the adsorption of an adsorbate as function of concentration while the temperature of the system is held constant. In an aspect, the adsorbate is CO₂ and concentration can be measured as CO₂ pressure. As described herein, isotherms can be performed with porous materials and using various mathematical models applied to calculate the apparent surface area. S. Brunauer, P.H. Emmett, and E. Teller. J. Am. Chem. Soc. 1938, 60, 309-319; K. Walton and R. Q. Snurr, J. Am. Chem. Soc. 2007, 129, 8552-8556; I. Langmuir, J. Am. Chem. Soc. 1916, 38, 2221.

As used herein, the term “step” in an isotherm is defined by a sigmoidal absorption profile, otherwise known as a Type-V isotherm. S. J. Gregg and K.S.W. Sing, Adsorption, Surface Area and Porosity, 2^{nd} Ed. Academic Press Inc., New York, NY, 1982, Ch V. The step can be generally defined by a positive second derivative in the isotherm, followed by an inflection point and a subsequent negative second derivative in the isotherm. The step occurs when adsorbent binding sites become accessible only at certain gas partial pressures, such as when CO₂ inserts into a metal-amine bond, or alternatively, when a dynamic framework pore is opened.

The term “salt(s)” includes salts of the compounds prepared by the neutralization of acids or bases, depending on the particular ligands or substituents found on the compounds described herein. When compounds of the present invention contain relatively acidic functionalities, base addition salts can be obtained by contacting the neutral form of such compounds with a sufficient amount of the desired base, either neat or in a suitable inert solvent. Examples of base addition salts include sodium, potassium, calcium, ammonium, organic amino, or magnesium salt, or a similar salt. Examples of acid addition salts include those derived from inorganic acids like hydrochloric, hydrobromic, nitric, carbonic, monohydrogencarbonic, phosphoric, monohydrogenphosphoric, dihydrogenphosphoric, sulfuric, monohydrogensulfuric, hydriodic, or phosphorous acids, and the like, as well as the salts derived from relatively nontoxic organic acids like acetic, propionic, isobutyric, butyric, maleic, malic, malonic, benzoic, succinic, suberic, fumaric, lactic, mandelic, phthalic, benzenesulfonic, p-tolylsulfonic, citric, tartaric, methanesulfonic, and the like. Certain specific compounds of the present disclosure contain both basic and acidic functionalities that allow the compounds to be converted into either base or acid addition salts. Hydrates of the salts are also included.

It is understood that, in any compound described herein having one or more chiral centers, if an absolute stereochemistry is not expressly indicated, then each center may independently be of R-configuration or S-configuration or a mixture thereof. Thus, the compounds provided herein may be enantiomerically pure or be stereoisomeric mixtures. In addition, it is understood that, in any compound described herein having one or more double bond(s) generating geometrical isomers that can be defined as E or Z, each double bond may independently be E or Z or a mixture thereof. Likewise, it is understood that, in any compound described, all tautomeric forms are also intended to be included.

In addition, the compounds provided herein may also contain unnatural proportions of atomic isotopes at one or more of the atoms that constitute such compounds. For example, the compounds may be radiolabeled with radioactive isotopes, such as for example tritium (3H), iodine-125 (¹²⁵I) or carbon-14 (¹⁴C). All isotopic variations of the subject compounds, whether radioactive or not, are intended to be encompassed within the scope of present disclosure.

Provided herein is a mixed-metal organic framework comprising a plurality of metal ions of two or more distinct elements and a plurality of organic linkers, where each linker is connected to at least one metal ion of the plurality of metal ions of two or more distinct elements. Also, provided herein is a mixed-metal mixed-organic framework system comprising a mixed-metal organic framework and a ligand, wherein the mixed-metal organic framework comprises a plurality of metal ions of two or more distinct elements, and a plurality of organic linkers, the linker being connected to one of the metal ions.

In an aspect, the mixed-metal organic framework presented herein has the general Formula I:

M¹ₓM²₍₂₋ₓ₎(A) I
wherein M¹ is a metal and M² is a metal, but M¹ is not M²;
X is a value from 0.01 to 1.99; and
A is an organic linker as described herein.

In an aspect, X is a value from 0.01 to 1.99. In an aspect, X is a value from 0.1 to 1. In an aspect, X is a value selected from the group consisting of 0.05, 0.1, 0.5 and 1. Further, while X and 2-X represent the relative ratio of M¹ to M², it should be understood that any particular stoichiometry is not implied in Formula I, Formula IA, Formula II or Formula III described herein. As such, the mixed-metal organic frameworks of the Formula I, IA, II or III are not limited to a particular relative ratio of M¹ to M². It is further understood that the metals are typically provided in ionic form and available valency will vary depending on the metal selected.

The metal of Formula I, IA, II and III described herein can be one of the elements of Period 4 Groups IIA, IIIB, IVB, VB, VIB, VIIB, VIII, IB and IIB of the Periodic Table and Period 3 Group IIA including Mg, Ca, V, Mn, Cr, Fe, Co, Ni, Cu and Zn. Furthermore, the mixed-metal organic framework comprises two more distinct elements as well as different combination of metals, theoretically represented as M¹ₓM²_{y} . . . . Mⁿ_{z}(A)(B)₂|x+y+ . . . +z=2 and M¹≠M²≠ . . . ≠Mⁿ.

In an aspect, M¹ is selected from Mg, V, Ca, Mn, Cr, Fe, Co, Ni, Cu and Zn; and M² is selected from Mg, V, Ca, Mn, Cr, Fe, Co, Ni, Cu and Zn, provided that M¹ is not M². In an aspect, M¹ is selected from the group consisting of Mg, Mn, Ni and Zn; and M² is selected from the group consisting of Mg, Mn, Ni and Zn; provided M¹ is not M². In an aspect, M¹ is Mg and M² is Mn. In an aspect, M¹ is Mg and M² is Ni. In an aspect, M¹ is Zn and M² is Ni. It is further understood that the metals are typically provided in an ionic form and the valency will vary depending on the metal selected. Further, the metals can be provided as a salt or in salt form.

In addition, the metal can be a monovalent metal that would make A the protonated form of the linker H-A. For example, the metal can be Na⁺ or one from Group I. Also, the metal can be one of two or more divalent cations (“divalent metals”) or trivalent cations (“trivalent metals”). In an aspect, the mixed metal mixed organic framework includes metals which are at oxidation states other than +2 can (i.e., more than just divalent, trivalent tetravalent,). The framework can have metals comprising a mixture of different oxidation states. Exemplary mixtures include Fe (II) and Fe (III), Cu (II) and Cu (I) and/or Mn (II) and Mn (III). More specifically, trivalent metals are metals having a +3 oxidation state. Some metals used to form the mixed-metal organic framework, specifically Fe and Mn, can adopt +2 (divalent) or +3 (trivalent) oxidation states under relatively gentle conditions. Chem. Mater, 2017, 29, 6181. Likewise, Cu (II) can form Cu (I) under gentle conditions. As such, any minor change to the oxidation state of any of the metals and/or selective change in the oxidation state of a metal can be used to modify the present mixed-metal organic frameworks. Furthermore, any combination of different molecular fragments C₁, C₂, . . . . Cₙ may exist. Finally, all of the above variations can be combined, for example, multiple metals (two or more distinct metals) with multiple valences and multiple charge-balancing molecular fragments.

Suitable organic linkers (also referred to herein as “linkers”) can be determined from the structure of the mixed-metal organic framework and the symmetry operations that relate the portions of the organic linker that bind to the metal node of the mixed-metal organic framework. A ligand which is chemically or structurally different, yet allows the metal node-binding regions to be related by a C₂ axis of symmetry, will form a mixed-metal organic framework of an identical topology. In an aspect, the organic linker can be formed by two phenyl rings joined at carbon 1,1′, with carboxylic acids on carbons 3, 3′, and alcohols on carbons 4,4′. Switching the position of the carboxylic acids and the alcohols (e.g., “pc-H₄DOBPDC” or “pc-MOF-274” described below) does not change the topology of the mixed-metal organic framework.

In an aspect, useful linkers include:

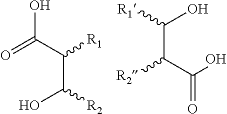

where R₁ is connected to R₁′ and R₂ is connected to R₂.″

Examples of such linkers include:

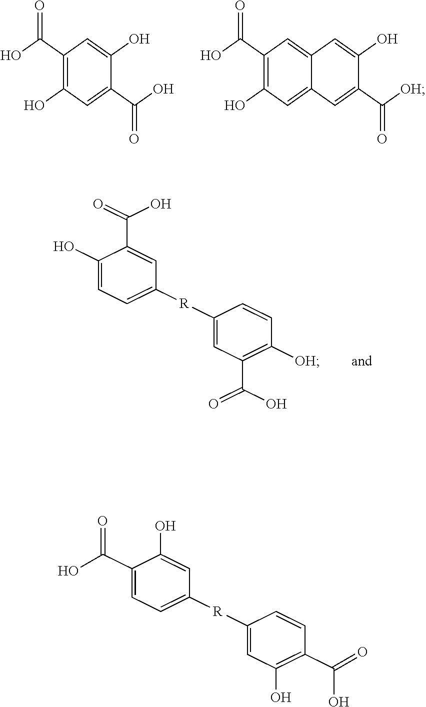

where R is any molecular fragment.

Examples of suitable organic linkers include para-carboxylate (“pc-linker”) such as 4,4′-dioxidobiphenyl-3,3′-dicarboxylate (DOBPDC); 4,4″-dioxido-[1,1′: 4′,1″-terphenyl]-3,3″-dicarboxylate (DOTPDC); and dioxidobiphenyl-4,4′-dicarboxylate (para-carboxylate-DOBPDC also referred to as PC-DOBPDC) as well as the following compounds:

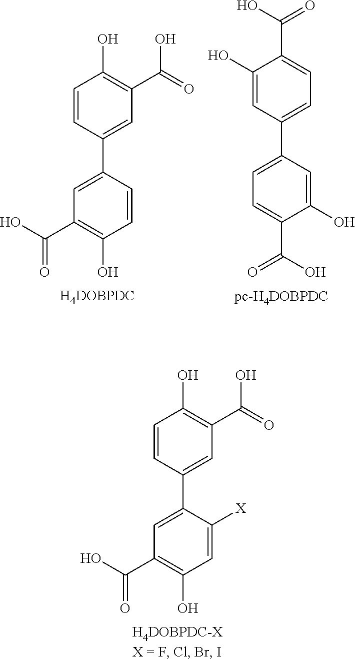

In an aspect, the organic linker has the formula:

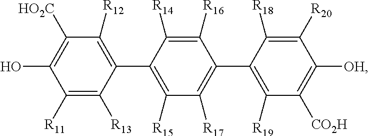

where R₁₁, R₁₂, R₁₃, R₁₄, R₁₅, R₁₆, R₁₇, R₁₈, R₁₉, and R₂₀ are each independently selected from H, halogen, hydroxyl, methyl, and halogen substituted methyl.

In an aspect, the organic linker has the formula:

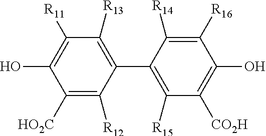

where, R₁₁, R₁₂, R₁₃, R₁₄, R₁₅, and R₁₆ are each independently selected from H, halogen, hydroxyl, methyl, and halogen substituted methyl.

In an aspect, the organic linker has the formula:

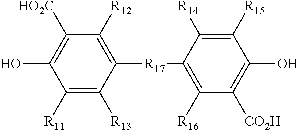

where R₁₁, R₁₂, R₁₃, R₁₄, R₁₅, and R₁₆ are each independently selected from H, halogen, hydroxyl, methyl, or halogen substituted methyl, and R₁₇ is selected from substituted or unsubstituted aryl, vinyl, alkynyl, and substituted or unsubstituted heteroaryl.

In an aspect, the organic linker has the formula:

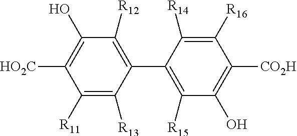

where R₁₁, R₁₂, R₁₃, R₁₄, R₁₅, and R₁₆ are each independently selected from H, halogen, hydroxyl, methyl, or halogen substituted methyl.
where R₁₁, R₁₂, R₁₃, R₁₄, R₁₅, and R₁₆ are each independently selected from H, halogen, hydroxyl, methyl, or halogen substituted methyl, and R₁₇ is selected from substituted or unsubstituted aryl, vinyl, alkynyl, and substituted or unsubstituted heteroaryl.

In an aspect, the organic linker includes multiple bridged aryl species such as molecules having two (or more) phenyl rings or two phenyl rings joined by a vinyl or alkynyl group.

In an aspect, provided herein the mixed-metal organic framework of structural Formula IA:

M¹ₓM²₍₂₋ₓ₎(A) IA
wherein M¹ is a metal independently selected from Mg, Ca, V, Mn, Cr, Fe, Co, Ni, Cu or Zn, or salt thereof;
M² is a metal independently selected from Mg, Ca, V, Mn, Cr, Fe, Co, Ni, Cu or Zn or salt thereof, but M¹ is not M²;
X is a value from 0.01 to 1.99; and
A is an organic linker as described herein.

As described herein, the mixed-metal mixed-organic frameworks are porous crystalline materials formed of two or more distinct metal cations, clusters, or chains joined by two or more multitopic (polytopic) organic linkers.

The present mixed-metal organic framework can be appended with amine molecule, referred to herein as “ligand,” that enables a step-shaped isotherm. The step-shaped isotherm occurs upon the insertion of the CO₂ into the metal-amine coordination bond, in turn creating a negative charge to localize on the oxygen of the CO₂. Diamines (molecules containing two amines) enable an amine to be bound to the metal, and a second amine to be positioned down the channel of the mixed-metal organic framework. Upon insertion of CO₂, the second amine accepts a proton, and thereby becomes positively charged, balancing the negative charge on the oxygen.

In an aspect, the mixed-metal organic framework system (sometimes referred to as “an appended mixed-metal organic framework”) is represented by Formula II

M¹ₓM²₍₂₋ₓ₎(A)(B) II
wherein M¹ is independently selected from the group consisting of Mg, Ca, V, Mn, Cr, Fe, Co, Ni, Cu and Zn;
M² is independently selected from the group consisting of Mg, Ca, V, Mn, Cr, Fe, Co, Ni, Cu and Zn, and M¹ is not M²;
X is a value from 0.01 to 1.99;
A is a linker as described herein; and

B is a ligand containing one or more groups capable of functioning as suitable Lewis base (electron donor) such as oxygen, phosphorus or sulfur or an amine having 1 to 10 amine groups.

Ligands suitable for use in the mixed-metal mixed-organic framework systems can have (at least) two functional groups: 1) A functional group used to bind CO₂ and 2) a functional group used to bind the metal. The second functional group that binds the metal can also be an amine. It is possible to use other functional groups such as oxygen containing groups like alcohols, ethers or alkoxides, carbon groups like carbenes or unsaturated bonds like alkenes or alkynes, or sulfur atoms.

Similarly, triamines can be used as the ligand appended to the mixed-metal frameworks provided herein. However, the triamine may not efficiently facilitate cooperative insertion of CO₂. On the other hand, tetramines (molecules having four amines) could accommodate two amines binding to the metal sites, creating the binding site for CO₂, while the other two amines were available to provide charge balance upon CO₂ insertion. Additionally, inclusion of tetramines can allow for each amine molecule to be bound more strongly to the mixed-metal organic framework (two amines binding to two metals per molecule, rather than one amine per molecule), providing some improvement in stability. Commercially available tetramines, as well as some other suitable amines are provided below:

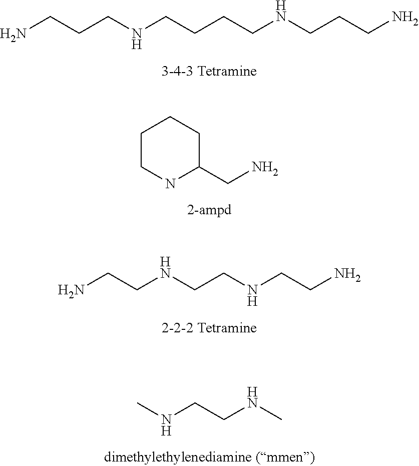

In addition, with the present mixed-metal organic frameworks, the ligand does not have to be an amine, but can be any Lewis base (electron donor) including various other atomic alternatives such as oxygen, phosphorus, or sulfur.

In an aspect, B is a ligand selected from the group consisting of:

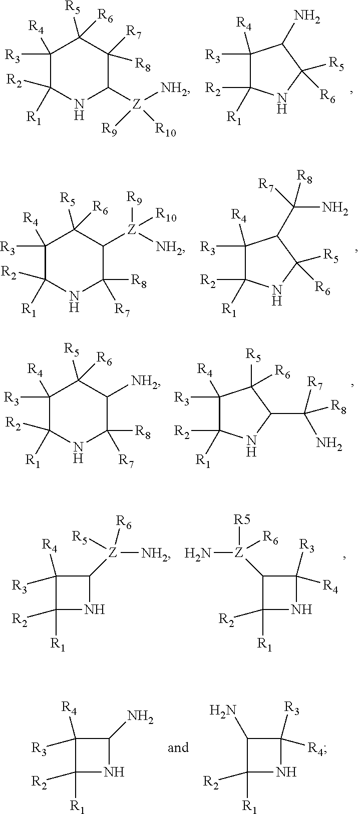

wherein Z is carbon, silicon, germanium, sulfur, or selenium, and R₁, R₂, R₃, R₄, R₅, R₆, R₇, R₈, R₉, and R₁₀ are each independently selected from H, halogen, methyl, halogen substituted methyl, and hydroxyl. In an aspect, R₁, R₂, R₃, R₄, R₅, R₆, R₇, R₈, R₉, and R₁₀ R₁, R₂, R₃, R₄, R₅, R₆, R₇, R₈, R₉, and R₁₀ are each H and Z is carbon.

In an aspect, the ligand is 2-(aminomethyl)-piperidine (2-ampd).

As provided herein, Formula I can include a solvent molecule coordinating to the metal sites, such as, M¹xM²₍₂₋ₓ₎(DOBPDC)(solvent)₂. As synthesized in the protocol described below, an exemplary solvent is N,N-Dimethylformamide (DMF). The solvent molecule can be removed by heating under vacuum, thereby generating an “activated” mixed-metal organic framework. Alternatively, the DMF (or other solvent molecule such as water, methanol, . . . ) can be displaced by treating the mixed-metal organic framework with the amine. This is referred to as an “appended” mixed-metal organic framework, or a mixed-metal mixed-organic framework system, and is the material that binds CO₂. For example, the mixed-metal mixed-organic framework, amine (“2-ampd”) will yield an exemplary Formula II, M¹ₓM²₍₂₋ₓ₎(DOBPDC)(2-ampd)₂. This material is also referred to as M¹ₓM²₍₂₋ₓ₎-EMM-44

Thus, Formula I, M¹ₓM²₍₂₋ₓ₎ A can include solvent-bound mixed-metal organic frameworks such as M¹ₓM²₍₂₋ₓ₎(DOBPDC)(DMF)₂ and be inactive or activated. On the other hand, Formula II, M¹ₓM²₍₂₋ₓ₎AB refers to a mixed-metal mixed-organic framework system.

As described herein, the mixed-metal mixed-organic frameworks are porous crystalline materials formed of two or more distinct metal cations, clusters, or chains joined by two or more multitopic (polytopic) organic linkers.

As such, a mixed-metal mixed-organic framework can also be represented by Formula III, M¹ₓM²₍₂₋ₓ₎(A¹ₐA²_{b}A³_{c} . . . . Aⁿ_{(1-a-b-c . . . )}) (III) wherein A¹ is a multitopic organic linker and A² is a multitopic organic linker dissimilar to A¹ and A³ is a multitopic organic linker dissimilar to A¹ and A²; and Aⁿ is a multitopic organic linker dissimilar to A¹, A² . . . and A⁽ⁿ⁻¹⁾.

In an aspect, ligands providing the mixed-metal, mixed-organic framework system can contain other structural elements used to coordinate the ligand to one or more metals of the framework system, including but not limited to, the following functional groups: carboxylate, triazolate, pyrazolate, tetrazolate, pyridines, amines, alkoxide and/or sulfate groups.

As described in the Example below, the present amine-appended mixed-metal organic framework systems can be prepared in a two-step process shown in scheme 1 as follows:

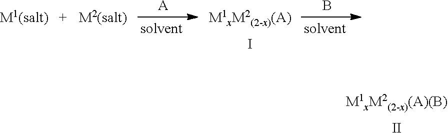

In step 1, a suitable salt of M¹ and a suitable salt of M² are combined with a linker A in an appropriate solvent and heated to provide the mixed-metal, mixed-organic framework system generally represented by Formula I. By way of example, MnCl₂ and Mg (NO₃)2.6H₂O are combined with 4,4′-dioxido-3,3′-biphenyldicarboxylate (H₄DOBPDC) in methanol and N,N′-dimethylformamide (DMF) to provide a composition of Formula I where M¹ is Mn, M² is Mg and A is DOBPDC.

In step 2, the mixed-metal organic framework of Formula I is combined with a ligand (B) in a suitable solvent. By way of example, M¹ is Mn, M² is Mg and A is DOBPDC, is combined with 2-ampd in toluene to provide the mixed-metal mixed-organic framework system of Formula II, where M¹ is Mn, M² is Mg, A is DOBPDC and B 2-ampd.

Also, provided herein are adsorption materials. The present adsorption material comprises the present mixed-metal, mixed-organic frameworks. The mixed-metal, mixed-organic framework comprises two or more metals and a plurality of organic linkers. Each organic linker is connected to a metal ion. The adsorption material further comprises a plurality of ligands. In an aspect, each respective ligand in the plurality of ligands is an amine or other Lewis base (electron donor) such as oxygen, phosphorus or sulfur appended to a metal ion of two or more distinct elements and the mixed-metal organic framework to provide a mixed-metal mixed-organic framework system.

The present mixed-metal mixed-organic framework systems represent a class of porous, crystalline adsorbents that enables greater functionality with reduced adsorbent mass and volume compared to traditional solid adsorbents. The present mixed-metal, mixed-organic framework system has coordinatively unsaturated metal centers (open metal sites) along the pore surfaces. The metal cations behave as Lewis acids that strongly polarize gas adsorbents and are further amenable to post-synthetic functionalization. In the mixed-metal mixed-organic framework system having well separated open metal sites, one amine of a diamine ligand molecule can bind to a metal cation as a Lewis base while the second amine remains available as a chemically reactive adsorption site. The metals in the mixed-metal mixed-organic framework system can be individual metal atoms bridged by a set of ligands or metal clusters (a collection of metal atoms that as a group interact with a set of ligands).

Some or all ligands of the mixed-metal, mixed-organic framework system include functional groups that are not coordinated to metal cations and are available to form reversible weak chemical bonds with CO₂. The reactive chemical atom can contain a lone pair of electrons including nitrogen, oxygen, sulfur, and phosphorous. In an aspect, this is a basic amine.

### Carbon Dioxide Applications

As described herein, a mixed-metal organic framework that contains more than one metal species of ions (a “cluster”) is later functionalized (or appended) with a diamine ligand (a “ligand”) to provide a mixed-metal mixed-organic framework system. The present mixed-metal mixed-organic framework systems are useful as adsorbent or adsorbent material of CO₂ in various applications and emission streams. Each novel mixed-metal organic framework described herein contains more than one metal species. The mixed-metal organic framework can be prepared from multiple metal sources and is appended by one or more organic ligand such as an amine to provide the mixed-metal mixed-organic framework system. The mixed-metal mixed-organic framework system displays a Type-V isotherm. By varying the ratio of metals incorporated in the mixed-metal organic framework, a position of the step in the isotherm can be varied as a function of CO₂ partial pressure.

For example, in an aspect, the mixed-metal organic framework can be later functionalized with the amine 2 ampd to provide the mixed-metal mixed-organic framework system, EMM-44. This mixed-metal mixed-organic framework system can reversibly and selectively bind to CO₂ and can be regenerated for repeat use by mild heating or by exposing to vacuum. The required percentage of CO₂ to be adsorbed in a gas stream and the required temperature for binding can be adjusted by varying the ratio of the two metal ions in the mixed-metal organic framework, allowing for broad distribution and implementation in CO₂ capture from diverse emission streams.

For example, in an aspect, a series of several mixed-metal organic frameworks, each comprising both Mg and Mn ions, can be functionalized with amine 2-ampd to provide a series of mixed-metal mixed-organic framework systems. When exposed to CO₂, the material with the least amount of Mn and greatest amount of Mg displays a Type-V isotherm at the lowest pressure of CO₂. The material with the most Mn and least amount of Mg displays a Type-V isotherm at the highest pressure of CO₂. A direct relationship is observed between the ratio of Mn to Mg contained in the mixed-metal mixed organic framework system and the pressure of CO₂ where the Type-V isotherm is observed.

As described in U.S. Pat. No. 9,861,953, Alkylamine Functionalized Metal-Organic Frameworks for Composite Gas Separations, a metal-organic framework, MOF-274, is taught. This framework can be synthesized from individual metal precursors capable of advantageous Type-V isotherms for CO₂ capture, but are not a mixed-metal organic framework as provided herein. Generally, adsorbent materials displaying a Type-V isotherm possess a greater working capacity than adsorbents having a similar overall adsorption capacity but also possess the more common type-I isotherm. Other such frameworks are described in J. Am. Chem. Soc, 2012, 134, 7056-7065, Nature, 2015, 519, 303-308, J. Am. Chem. Soc, 2017, 139, 10526-10538, J. Am. Chem. Soc. 2017, 139, 13541-13553, and Chem Sci, 2018, 9, 160.

Methods of use for the present adsorption materials include a variety of gas separation and manipulation applications including the isolation of individual gases from a stream of combined gases, such as carbon dioxide/nitrogen, carbon dioxide/hydrogen, carbon dioxide/methane, carbon dioxide/oxygen, carbon monoxide/nitrogen, carbon monoxide/methane, carbon monoxide/hydrogen, hydrogen sulfide/methane and hydrogen sulfide/nitrogen.

Among the primary benefits of physiorption onto solid materials is the low regeneration energy compared to that required for aqueous amines. However, this benefit frequently comes at the expense of low capacity and poor selectivity. The present systems provide adsorbents (adsorbent materials) that can bridge the two approaches through the incorporation of sites that bind CO₂ by chemisorption onto solid materials. These adsorption materials may eliminate the need for aqueous solvents, and may have significantly lower regeneration costs compared with traditional amine scrubbers, yet maintain their exceptional selectivity and high capacity for CO₂ at low pressures.

Generally, as shown in FIG. 11, metal organic frameworks are porous, crystalline solids subsequently functionalized with the incorporation of alkylamines. Similarly, the mixed-metal organic frameworks provided herein are porous, crystalline solids that are subsequently functionalized with the incorporation of alkylamines to exhibit enhanced basicity over aromatic amines, and are capable of adsorbing acid gases. The present disclosure teaches adsorption materials comprising the mixed-metal organic framework having two different metals distinguishable from the prior art metal organic frameworks having a single type of metal by the highly desired Type-V isotherm and where the step location can be adjusted through the mixed metal selection (choice of metals) or by varying the ratio of the metals in the mixed-metal organic framework.

In an aspect, the mixed-metal mixed-organic framework system can separate gases at low temperatures and pressures. The mixed-metal mixed-organic framework systems are useful for pre-combustion separation of carbon dioxide and hydrogen and methane from a stream of gases and for separation of carbon dioxide from a stream of post-combustion flue gases at low pressures and concentrations. The mixed-metal, organic framework can be adapted to many different separation needs.

More specifically, in an aspect of the present disclosure, there are a number of technical applications for the disclosed adsorption materials. One such application is carbon capture from coal flue gas or natural gas flue gas. The increasing atmospheric levels of carbon dioxide (CO₂), which are contributing to global climate change, warrant new strategies for reducing CO₂ emissions from point sources such as power plants. In particular, coal-fueled power plants are responsible for 30-40% of global CO₂ emissions. See, Quadrelli et al., 2007, “The energy-climate challenge: Recent trends in CO₂ emissions from fuel combustion,” Energy Policy 35, pp. 5938-5952, which is hereby incorporated by reference. Thus, there remains a continuing need for the development of new adsorbents for carbon capture from coal flue gas, a gas stream consisting of CO₂ (15-16%), 02 (3-4%), H₂O (5-7%), N₂ (70-75%), and trace impurities (e.g. SO₂, NOx) at ambient pressure and 40° C. See, Planas et al., 2013, “The Mechanism of Carbon Dioxide Adsorption in an Alkylamine-Functionalized Metal-organic Framework,” J. Am. Chem. Soc. 135, pp. 7402-7405, which is hereby incorporated by reference. Similarly, growing use of natural gas as a fuel source necessitates the need for adsorbents capable of CO₂ capture from the flue gas of natural gas-fired power plants. Flue gas produced from the combustion of natural gas contains lower CO₂ concentrations of approximately 4-10% CO₂, with the remainder of the stream consisting of H₂O (saturated), O₂(4-12%), and N₂ (balance). In particular, for a temperature swing adsorption process an adsorbent should possess the following properties: (a) a high working capacity with a minimal temperature swing, in order to minimize regeneration energy costs; (b) high selectivity for CO₂ over the other constituents of coal flue gas; (c) 90% capture of CO₂ under flue gas conditions; (d) effective performance under humid conditions; and (d) long-term stability to adsorption/desorption cycling under humid conditions.

Another such application is carbon capture from crude biogas. Biogas, the CO₂/CH₄ mixtures produced by the breakdown of organic matter, is a renewable fuel source with the potential to replace traditional fossil fuel sources. Removal of CO₂ from the crude biogas mixtures is one of the most challenging aspects of upgrading this promising fuel source to pipeline quality methane. Therefore, the use of adsorbents to selectively remove CO₂ from CO₂/CH₄ mixtures with a high working capacity and minimal regeneration energy has the potential to greatly reduce the cost of using biogas in place of natural gas for applications in the energy sector.

The disclosed compositions (adsorption materials) can be used to strip a major portion of the CO₂ from the CO₂-rich gas stream, and the adsorption material enriched for CO₂ can be stripped of CO₂ using a temperature swing adsorption method, a pressure swing adsorption method, a vacuum swing adsorption method, a concentration swing adsorption method, or a combination thereof. Example temperature swing adsorption methods and vacuum swing adsorption methods are disclosed in International Publication Number WO2013/059527 A¹.

Isosteric heat of adsorption calculations provide an indicator of the strength of the interaction between an adsorbate and adsorbent, specifically determined from analysis of adsorption isotherms performed across a series of different temperatures. J. Phys. Chem. B, 1999, 103, 6539-6545; Langmuir, 2013, 29, 10416-10422. Differential scanning calorimetry is a technique which measures the amount of energy released or absorbed as a parameter (such as temperature or CO₂ pressure) varies.

### Example I

Preparation of the Mixed-metal mixed-organic framework system, EMM-44

### Synthesis of Mixed-Metal Organic Framework, MOF-274

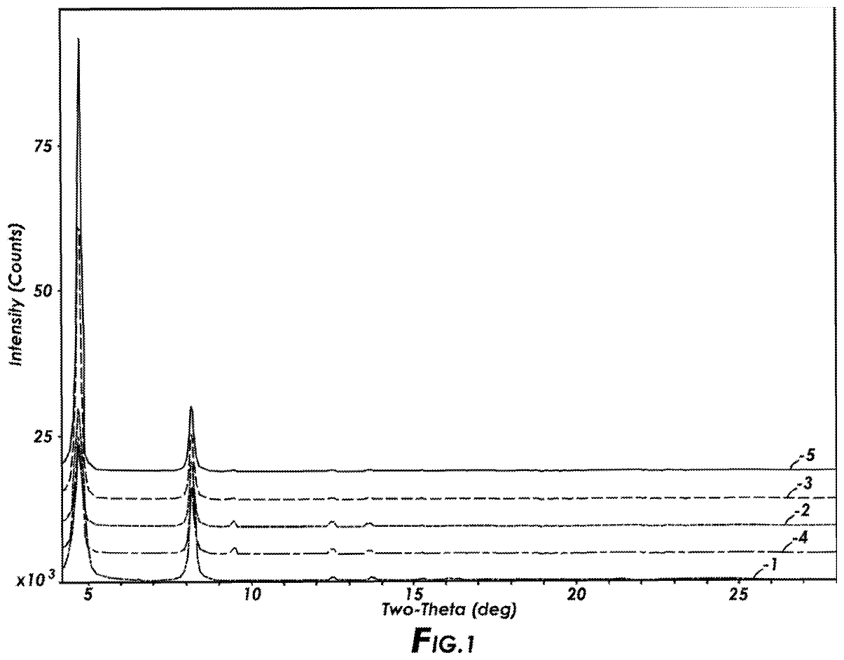

Synthesis of mixed-metal framework: MOF-274, M¹ₓM² (2-x) (DOBPDC): 241.15 mg MnCl₂·4 H₂O (1.219 mmol), 312.65 mg Mg (NO₃)₂·6H₂O (1.219 mmol), and 267.15 mg 4,4′-dioxido-3,3′-biphenyldicarboxylate (H₄DOBPDC, 0.975 mmol) were combined in a 3-neck 250-mL round bottom flask with stir bar. 49 mL deoxygenated methanol and N,N′-dimethylformamide (DMF) were transferred to the metal and ligand-containing solution while stirring. The solution was stirred for 20 minutes to ensure all solids were thoroughly dissolved. The reaction solution was split in 15 mL aliquots and transferred into 23-mL Teflon-lined Parr reactors. All reactors were sealed and heated at 120° C. for 96 hours under static conditions. Upon cooling naturally to ambient temperature, the mother liquor was removed by decantation, and the solid was washed three times over 24 hours with DMF, then three times over 24 hours with methanol. Approximately 40 mg of mixed-metal organic framework was collected, and the methanol was removed by slow centrifugation followed by pipetting. As provided in FIG. 1, Samples 1 through 5 were different batches of the same material where the amine was not appended, and the framework has not been functionalized or activated.

Amine Appending: Generation of the Mixed-metal mixed-organic framework system EMM-44:

Following coordination of the amine 2-ampd to an open metal site of any MOF-274 framework, the adsorbent material becomes known as EMM-44, mixed-metal mixed-organic framework system. The above M¹ M² (2-x) (DOBPDC) was then washed once with toluene and resuspended in toluene before being transferred into a 20 vol % solution of the amine 2-ampd in toluene. The solution was allowed to sit 24 hours, then collected by slow centrifugation, washed three times in toluene, and stored in toluene. These 2-ampd-appended MOFs are referred to as M¹ₓM² (2-X-EMM-44, a mixed-metal mixed-organic framework system, where M¹ and M² are the mixed metals used during synthesis, and x is the amount of M¹ in the adsorbent material.

### Characterization of Mixed-Metal Framework System EMM-44

Inductively Coupled Plasma-Optical Emission Spectroscopy, also known as Inductively Coupled Plasma-Atomic Emission Spectroscopy (ICP-AES), measures element-specific emission spectra from metals, metalloids, and some non-metals in a heated plasma. It is a routine elemental analysis technique, capable of providing metal quantification in a given sample. ICP-OES was performed by Galbraith Laboratories, Inc, Knoxville, TN. Galbraith's general method for ICP-OES analysis was written from nationally accepted methods, specifically EPA SW846 6010B, also meeting the general guidance of USP.

### ICP-OES of MOF-274 Framework Using the Above Synthesis.

Samples were submitted in duplicate, obtained from the same synthetic batch (Table 1A). As provided in Table 1B, data indicated that each of the samples contain both metals included in the original synthesis solution, which is the desired outcome.

TABLE 1A

| Sample | Description |
|---|---|
| MOF-274 − 1 | MOF synthesized only with Mg |
| MOF-274 − 2 | MOF synthesized only with Mg |
| Mn₁Mg₁-MOF-274 − 1 | MOF synthesized with 1:1 Mg and Mn |
| Mn₁Mg₁-MOF-274 − 2 | MOF synthesized with 1:1 Mg and Mn |
| Mn₁Mg₁-MOF-274 − 1 | MOF synthesized with 1:1 Mg and Ni |
| Mn₁Mg₁-MOF-274 − 2 | MOF synthesized with 1:1 Mg and Ni |

TABLE 1B

| Sample | Mg | Mn | Ni | Mg/Mn | Mg/Ni |
|---|---|---|---|---|---|
| MOF-274(Mg) − 1 | 8.07% | 0.041% | <0.003% | 197 | — |
| MOF-274(Mg) − 2 | 8.25% | 0.043% | <0.003% | 192 | — |
| Mn₁Mg₁-MOF-274 − 1 | 3.62% | 7.50% | — | 0.5 | — |
| Mn₁Mg₁-MOF-274 − 2 | 1.91% | 3.86% | — | 0.5 | — |
| Mn₁Mg₁-MOF-274 − 1 | 5.19% | — | 2.54% | — | 2.0 |
| Mn₁Mg₁-MOF-274 − 2 | 5.45% | — | 4.85% | — | 1.1 |

### Characterization of the Mixed-Metal Organic Framework

Powder x-ray diffraction (PXRD). Mixed-metal organic frameworks were suspended in methanol by thorough mixing and sonication, then drop-cast onto a zero-background cell. Powder x-ray diffraction data were collected on a Bruker D8 Endeavor instrument with the x-ray generator running at 45 kV/40 mA and an opening degree of 0.02° collecting the spectrum between 4-50° two-theta for 10 minutes. As shown in FIG. 1, powder x-ray diffraction pattern of representative MOF-274 are shown. Samples 1 through 5 are different batches of the same material where the amine was not appended, and the framework has not been functionalized or activated. As shown in FIG. 1, powder x-ray diffraction pattern of representative MOF-274 are shown.

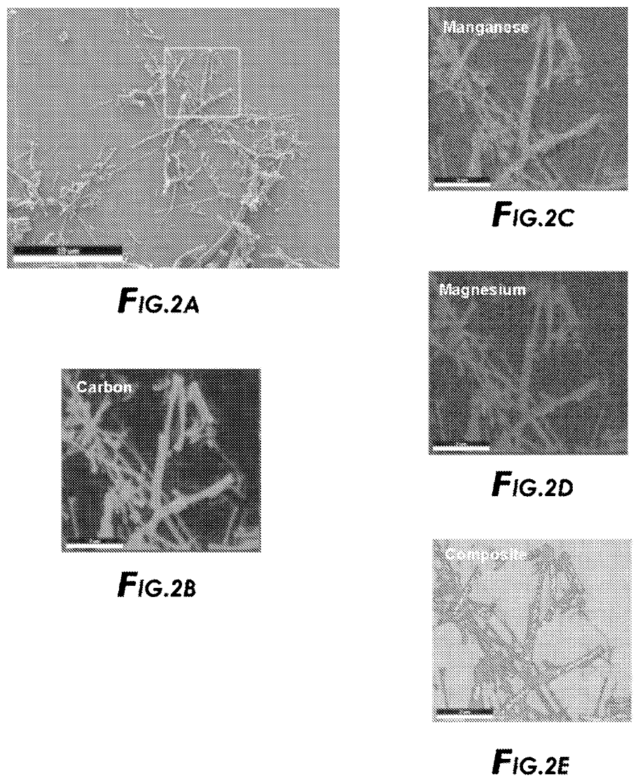

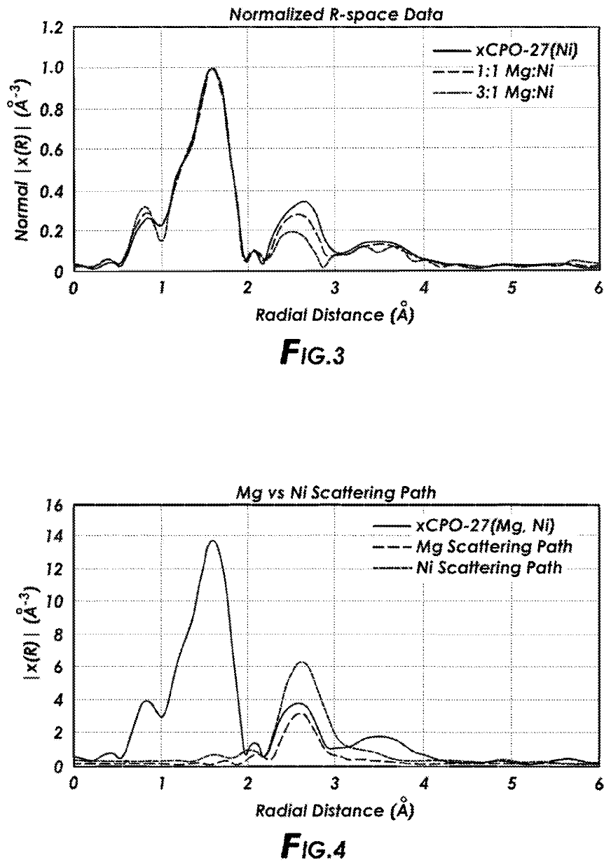

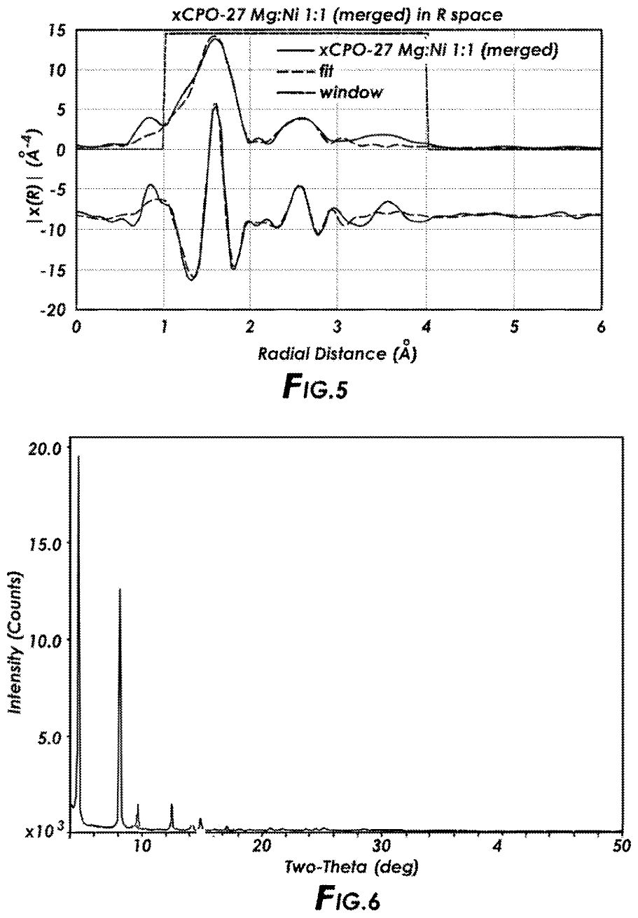

Energy-dissipative x-ray spectroscopy (EDS). A dilute solution of mixed-metal organic framework in ethanol was suspended by sonication and drop-cast onto a doped Si chip and fixed with carbon tape to an aluminum SEM stub. EDS data were collected on a ZEISS FIB-SEM Crossbeam 540 at 3 kV, <1-5 nA, and with a “short” dwell time. FIGS. 2A through 2D provide representative data collected by energy-dissipative x-ray spectroscopy (“EDS) demonstrating that the mixed-metal organic framework of manganese and magnesium, where manganese and magnesium are co-located in the same crystals. These mixed-metal organic frameworks do not form discrete crystalline domains.

X-ray absorption spectroscopy (XAS) and extended x-ray absorption fine structure (EXAFS). 50 mg of each mixed-metal organic framework analyzed was collected from methanol by centrifugation, with solvent removed by decanting. Sufficient BN was added to each mixed-metal organic framework to dilute the concentration of x-ray absorbing metal to between 1.25 and 1.75 edge steps. Methanol was added in sufficient volume to permit full resuspension of the mixed-metal mixed-organic framework and BN, with the mixture sonicated to achieve homogeneous dispersion. The mixture was recollected by centrifugation and the solvent removed by decanting. Under an inert atmosphere approximately 10 mg of each mixed-metal organic framework/BN mixture was packed into a self-supported pellet for XAS analysis.

X-ray absorption data were collected at the metal K-edge in transmission mode, following customary data practices for collecting x-ray absorption data. S. Calvin. XAFS for Everyone, CRC Press, Boca Raton, FL, 2013. Specifically, X-rays were monochromatized and detuned to reduce the contribution of higher order harmonics. A reference foil of the same metal being analyzed was measured simultaneously during data collection for energy calibration and data alignment. The flux of the incident beam, transmitted beam, and reference were all measured by 20 cm ion chambers with gas compositions appropriate for absorbing approximately 10%, 10%, and 100% of the x-ray flux, respectively.

Data were processed and analyzed using the Athena and Artemis programs of the IFEFFIT package based on FEFF 6. B. Ravel and M. Newville, J. Synchrotron Radiat., 2005, 12, 537-541; J. J. Rehr and R.C. Albers, Rev. Mod. Phys., 2000, 72, 621-654. Reference spectra were aligned to the first zero-crossing of the second derivative of the normalized u (E) data, which was subsequently calibrated to the literature value for E₀ for the corresponding metal K-edge. The aligned spectra were averaged in μ(E) prior to normalization. The background of the XAS spectrum was removed by spline fitting and the data were assigned a R_{bkg} value of 1.0. The window used for fitting the extended x-ray absorption fine structure (EXAFS) was determined such that a common window could be used for all samples of a given mixed metal class (e.g. all mixed-metal MOFs containing Mn and Mg). The R-space was fit over a range encompassing the first two shells of atoms surrounding the absorbing atom, typically from 1-3 Å. The k-space data were windowed from approximately 3-11 Å⁻¹, with precise values determined by when the data crossed the x-axis to minimize termination effects.

Normalized Fourier-transformed extended x-ray absorption spectroscopy data for mixed-metal organic framework Ni₁Mg₁-MOF-274 (50% Ni) was collected at the Ni K-edge. FIG. 3. Noteworthy is the feature around 2.5 Å decreases as the Mg: Ni ratio increases. Comparison of the scattering paths reveals that Mg is a weaker backscatterer than Ni. Thus, inclusion of Mg in the Ni coordination environment can result in suppression of the feature at 2.5 Å. This behavior will not be observed, however, if the metals segregate in separate domains of the same mixed-metal organic framework, or if they form a mixture of in discrete crystallites. Mg can exist in a local Ni environment, when Mg and Ni are co-located in the same framework, putatively with random distribution.

Fourier transformed extended x-ray absorption fine structure (EXAFS) data were fit using typical best practices. A structure model was obtained by modifying the cif file for MOF-274 (Zn) to make the metal in the mixed-metal organic framework the metal of interest. R. Siegelman, T. McDonald, et al. J. Am. Chem. Soc., 2017, 139, 10526-10538. Direct scattering paths between metals representing M¹-M¹, as would be found in a MOF containing only metal, and M¹-M², as would be found in a mixed-metal organic framework, were also prepared by modifying the cif file. Sample families were fit simultaneously (e.g. 100% Mn, 50% Mn, 25% Mn, 10% Mn, and 5% Mn) using scattering paths calculated from the aforementioned structure models. Global parameters include the amplitude reduction factor (S₀²); energy shift of the photoelectron (ΔE₀); the change in R_{eff} (ΔRᵢ) for scattering paths from the two nearest neighbor oxygen, the nearest neighbor carbon, and the nearest neighbor metal (including both possibilities of Mg(ΔR_{Mg}) and Mn (ΔR_{Mn})); and the mean square relative displacement of the scattering element (including either a light element, (σ₀²) or a metal (σM²)). With the exception of the metal-metal scattering paths, the degeneracy of all scattering paths was defined based on the coordination environment observed in the structure model. Initial fits were obtained with k-weighting equal to 1, 2, and 3, before a final fit was obtained solely with k-3 weighted data for each sample. All data were fit in R-space. The number of variables were not allowed to exceed ⅔ the number of independent points, in accordance with the Nyquist criterion. S. Calvin, XAFS for Everyone, CRC Press, Boca Raton, FL, 2013.

In the mixed-metal organic framework, to determine the scattering contribution from M¹-M¹ vs M¹-M² a freely varying parameter (e.g. “frac”) representing the fraction of M¹-M² scattering was created and refined as part of the fitting process. This parameter then multiplied the S₀² parameter for the M¹-M² scattering path, attenuating the contribution to the fit due to the direct correlation of S₀² with scattering path degeneracy. The complementary contribution from M¹-M¹ scattering was subsequently defined to be (1-frac), which then multiplied the So-parameter of the M¹-M¹ scattering path. A different parameter was created for each sample in a given mixed-metal series. (E.g. different “frac” parameters were created for 50% Mn, 25% Mn, 10% Mn, and 5% Mn systems so that each could refine to a different ratio of scattering contributions, representative of the different metal distributions. Note, a 100% Mn system would not require a fractional scattering parameter, as all scattering contributions are necessarily M¹-M¹.) Thus, in addition to providing a high-quality fit, a physically meaningful M¹: M² ratio can be corroborated by EXAFS analysis for a bulk sample.

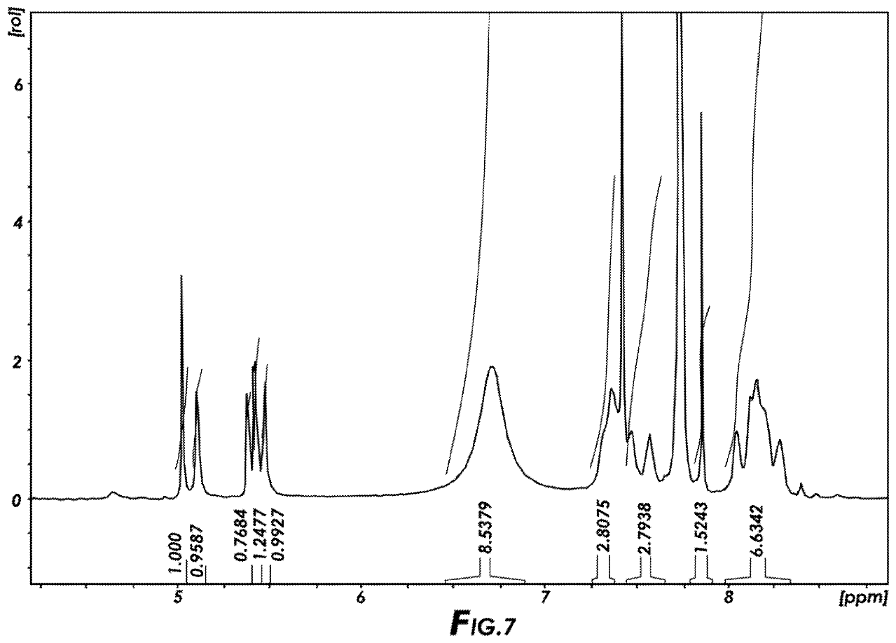

FIG. 4 provides representative fitted extended x-ray absorption fine structure (EXAFS) spectrum for a Ni₁Mg₁-MOF-274 (50% Ni) system. The spectrum was fit using a combination of Ni—Ni and Ni—Mg scattering paths to represent the feature at 2.5 Å, as described above. Fits have been successfully obtained for a Ni_{0.5}Mg_{1.5}-MOF-274 (25% Ni) and pure Ni MOF-274 material as well. Data have also been collected for Mg/Mn MOF-274 and Zn/Ni MOF-274. These preliminary results are consistent with the Mg/Ni results described below.

As shown in FIG. 5, the EXAFS results confirm the Ni atoms are not localized in isolated domains, but instead are dispersed throughout the mixed-metal organic framework. Thus, these are truly mixed-metal organic frameworks, and not a mixture of two metal organic frameworks where each metal organic framework contains only one metal species.

### Activation

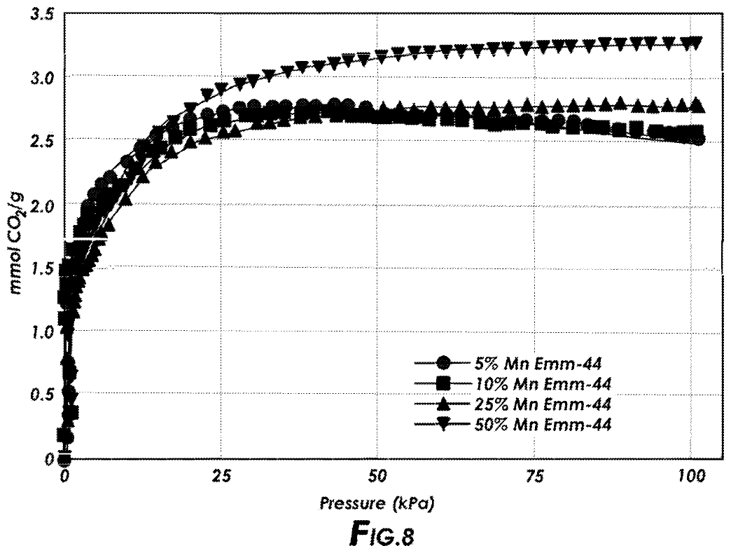

In FIG. 6, the representative powder x-ray diffraction pattern of mixed-metal mixed-organic framework system EMM-44 (the 2-ampd-appended mixed-metal MOF-274) demonstrates that crystallinity is preserved after appending the amine into the framework.

Mixed-metal organic frameworks were digested and analyzed by 1H NMR as per the protocol articulated in the literature. P. Milner, R. Siegelman, et al. J. Am. Chem. Soc. 2017, 139, 13541-13553. FIG. 7 provides a representative 1H NMR of mixed-metal mixed-organic framework system EMM-44, following digestion with DCI in DMSO-d₆. The extent of amine loading can be obtained by comparing the peak areas for the MOF-274 ligand and 2-ampd. For the mixed-metal framework system Mn_{0.5}Mg_{1.5}-EMM-44, the Mn_{0.5}Mg_{1.5}-MOF-274 was 92% functionalized with 2-ampd. Comparable loadings were obtained for several samples of mixed-metal mixed-organic framework EMM-44, prepared with various Mg: Mn ratios.

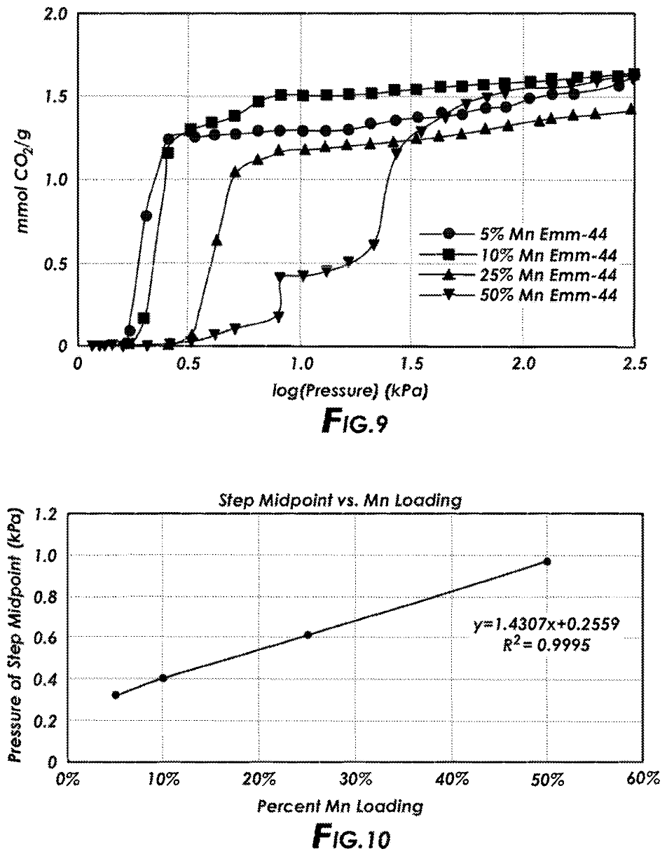

As shown in FIG. 8, CO₂ isotherms for mixed-metal mixed-organic framework systems: Mn_{0.1}Mg_{1.9}-EMM-44 (5% Mn), Mn_{0.2}Mg_{1.8}-EMM-44 (10% Mn), Mn_{0.5}Mg_{1.5}-EMM-44 (25% Mn) and Mn₁Mg₁-EMM-44 (50% Mn) MOF-274, each show an unusual and highly desired Type-V isotherm.

FIG. 9 shows CO₂ isotherm for the mixed-metal mixed-organic framework system Mn_{0.1}Mg_{1.9}-EMM-44 (5% Mn), Mn_{0.2}Mg_{1.8}-EMM-44 (10% Mn), Mn_{0.5}Mg_{1.5}-EMM-44 (25% Mn) and Mn₁Mg₁-EMM-44 (50% Mn) MOF-274, plotted on a log scale to more fully display the characteristic low-pressure “step” in the Type-V isotherm. Increasing the fraction of Mn in the mixed-metal organic framework increases the partial pressure of CO₂ necessary to induce CO₂ uptake.

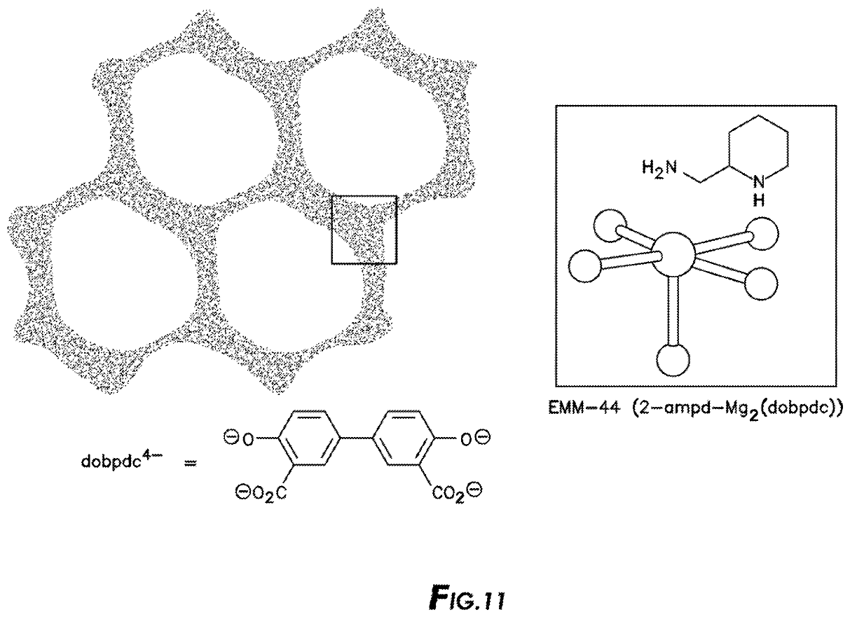

FIG. 10 depicts the position of the CO₂-isotherm midpoint for the mixed-metal, mixed-organic framework Mn Mg₂-x-EMM-44 as a function of Mn loading, replotted from the data presented above. In summary, mixed-metal, mixed-organic framework systems EMM-44, are adsorbent materials that exhibit Type-V step CO₂ isotherm profiles where the step location is tunable through the mixed metal choice or ratio of metals in the mixed-metal organic framework. Characterization has shown that the metals are co-located in the mixed-metal organic framework crystal, rather than in separate metal chains or distinct crystallites.

Certain features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

The foregoing description of the disclosure illustrates and describes the present methodologies. Additionally, the disclosure shows and describes exemplary methods, but it is to be understood that various other combinations, modifications, and environments may be employed and the present methods are capable of changes or modifications within the scope of the concept as expressed herein, commensurate with the above teachings and/or the skill or knowledge of the relevant art.

We claim:

1. A mixed-metal organic framework system, comprising:
a mixed-metal organic framework of the formula: M¹ₓM²_{y}M³_{z}(A) where M¹, M², and M³ are each independently different metal cations, x+y+z=2, and A is a disalicylate organic linker, wherein M¹, M², and M³ are selected independently from Ca²⁺, Mg²⁺, Fe²⁺, Cr²⁺, V²⁺, Mn²⁺, Co²⁺, Ni²⁺, Zn²⁺, Cu²⁺; and
a ligand that is an amine.

2. The mixed-metal organic framework of claim 1, wherein the mixed-metal organic framework comprises a plurality of disalicylate linkers A, wherein each linker comprises one or more aromatic rings, each aromatic ring comprising a carboxylate functional group and an alcohol functional group, the carboxylate functional group and the alcohol functional groups are adjacent to one another on each aromatic ring, and each aromatic ring is positioned at a greatest distance from the other.

3. The mixed-metal organic framework of claim 1, wherein M¹, M², and M³ are each independently a divalent metal cation.

4. The mixed-metal organic framework of claim 1, wherein A is a plurality of linkers selected independently from a group consisting of: 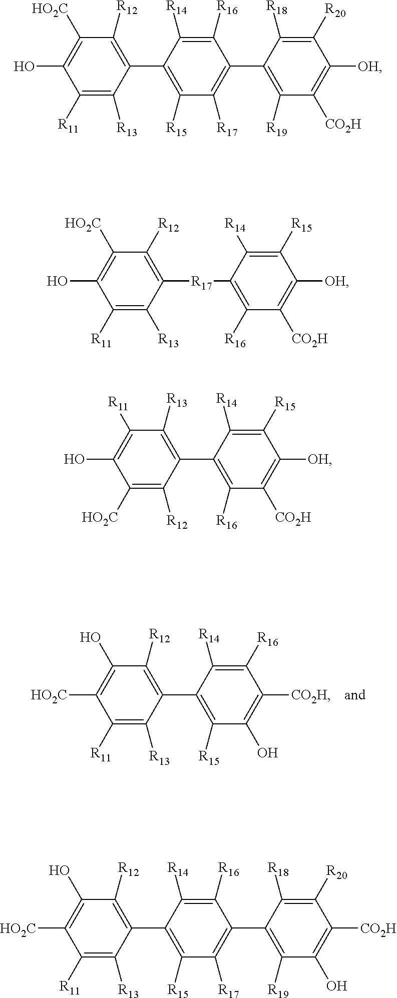
wherein R₁₁, R₁₂, R₁₃, R₁₄, R₁₅, R₁₆, R₁₇, R₁₈, R₁₉, and R₂₀ are each independently selected from H, halogen, hydroxyl, methyl, and halogen substituted methyl; and
R₁₇ is selected from the group consisting of substituted or unsubstituted aryl, vinyl, alkynyl, substituted or unsubstituted heteroaryl, divinyl benzene, and diacetyl benzene.

5. The mixed-metal organic framework of claim 1, wherein the mixed metal organic framework provides an X-ray diffraction pattern that can be indexed to a hexagonal unit cell.

6. The metal-organic framework of claim 5, wherein an a axis of the unit cell and a b axis of the unit cell are each greater than 18 Å, and a c axis is greater than 6 Å.

7. The mixed-metal organic framework of claim 5, where the unit cell is selected from spacegroups 168 to 194.

8. The mixed-metal organic framework of claim 1, further comprising a metal rod structure.

9. The mixed-metal organic framework of claim 8 having a hexagonal pore oriented parallel to the metal rod structure.

10. The mixed-metal organic framework of claim 1, wherein the mixed-metal organic framework displays a (3,5,7)-c msi net, or wherein the mixed-metal organic framework displays a (3,5,7)-c msg net.

11. The mixed-metal organic framework of claim 1, wherein the mixed-metal organic framework expresses peak maxima in the X-ray diffraction pattern at 30° C. after drying at 250° C. under N₂ for 30 minutes at:
```
d(Å)
18.65 ± 0.5
10.79 ± 0.5
  9.35 ± 0.5
  7.07 ± 0.5
  6.51 ± 0.5
  6.24 ± 0.5
  5.84 ± 0.5
  5.41 ± 0.5
  5.19 ± 0.5
```

12. The metal-organic framework system of claim 1, wherein the ligand is a diamine.

13. The metal-organic framework system of claim 12, wherein the diamine is independently selected from: 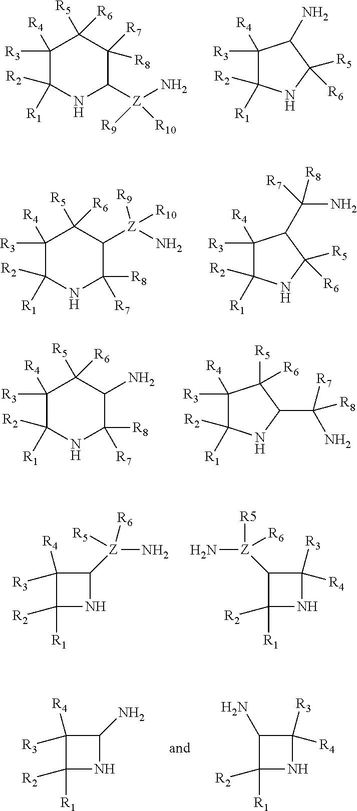
wherein Z is independently selected from carbon, silicon, germanium, sulfur and selenium; and
R₁, R₂, R₃, R₄, R₅, R₆, R₇, R₈, R₉, and R₁₀, are each independently selected from H, halogen, methyl, halogen substituted methyl and hydroxyl.

14. The mixed-metal organic framework system of claim 12, wherein the diamine ligand is selected from one of: dimethylethylenediamone (mmen) or 2-(aminomethyl) piperidine 2-ampd.

15. The mixed-metal organic framework system of claim 1, wherein the ligand is a tetramine.

16. The mixed-metal organic framework system of claim 15, wherein the tetramine is selected from one of 3-4-3 tetramine (spermine) or 2-2-2 tetramine.

17. The mixed-metal organic framework system of claim 1, further comprising a ligand wherein the ligand is a triamine.

18. The metal-mixed organic framework system of claim 17, wherein the ligand is selected from:

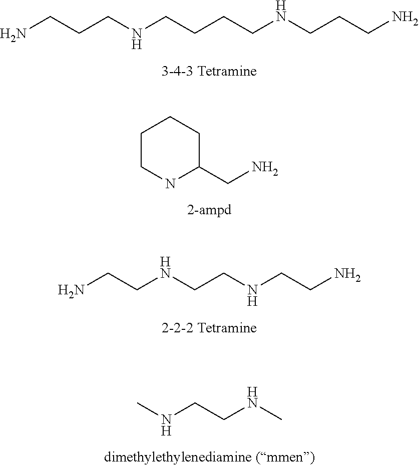

19. A method of synthesizing the mixed-metal organic framework of claim 1 comprising the steps of:
1) contacting a solution comprising 2 or more sources of 2 or more distinct metallic elements and an organic linker capable of bridging metal cations, the metallic elements being selected independently from Ca, Mg, Fe, Cr, V, Mn, Co, Ni, Zn, Cu, and
2) heating the mixture to produce the mixed-metal organic framework of any of the preceding claims.

20. The method of claim 19, wherein the solution comprises an elemental metal or a salt of the metal in which the counter anion comprises a nitrate, acetate, carbonate, oxide, hydroxide, fluoride, chloride, bromide, iodide, phosphate, or acetylacetonate.
